(19) United States
(12) Patent Application Publication
(10) Pub. No.: US 2025/0138718 A1
(43) Pub. Date: May 1, 2025

(54) INTERFACE CONTROL METHOD AND APPARATUS, TERMINAL, AND STORAGE MEDIUM

(71) Applicant: Tencent Technology (Shenzhen) Company Limited, Shenzhen (CN)

(72) Inventors: Jiaqi PAN, Shenzhen (CN); Ying DENG, Shenzhen (CN); Linying XIE, Shenzhen (CN); Zefeng YANG, Shenzhen (CN); Weixiang YU, Shenzhen (CN); Yun YANG, Shenzhen (CN); Yinglei WANG, Shenzhen (CN); Kaiqin XU, Shenzhen (CN); Wenyi LI, Shenzhen (CN)

(21) Appl. No.: 19/008,295

(22) Filed: Jan. 2, 2025

Related U.S. Application Data
(63) Continuation of application No. PCT/CN2023/129519, filed on Nov. 3, 2023.

(30) Foreign Application Priority Data
Jan. 17, 2023 (CN) 202310089176.8

(51) Int. Cl. G06F 3/04845; G06F 3/0346; G06F 3/042; G06F 3/0488

(52) U.S. Cl. CPC G06F 3/04845; G06F 3/0346; G06F 3/0421; G06F 3/0488

(57) ABSTRACT

This application discloses an application interface control method performed by a computer device. The method includes: displaying an application interface in a landscape state, the application interface including operable elements, and the operable elements including at least one first operable element located in a one-handed operation region and at least one second operable element located outside the one-handed operation region; receiving a shielding operation on a light sensor, the light sensor being configured to collect light intensity of an environment in which the computer device is located, and the light sensor being located in the one-handed operation region in the landscape state; and controlling, based on the shielding operation, the application interface to move, to cause the second operable element to move into the one-handed operation region. Using the foregoing method helps improve efficiency of an one-handed operation in a landscape state.

### CROSS-REFERENCE TO RELATED APPLICATIONS

This application is a continuation application of PCT Patent Application No. PCT/CN2023/129519, entitled “INTERFACE CONTROL METHOD AND APPARATUS, TERMINAL, AND STORAGE MEDIUM” filed on Nov. 3, 2023, which claims priority to Chinese Patent Application No. 202310089176.8, entitled “INTERFACE CONTROL METHOD AND APPARATUS, TERMINAL, AND STORAGE MEDIUM” filed on Jan. 17, 2023, both of which are incorporated herein by reference in their entirety.

### FIELD OF THE TECHNOLOGY

Embodiments of this application relate to the field of human-computer interaction technologies, and in particular, to an interface control method and apparatus, a terminal, and a storage medium.

### BACKGROUND OF THE DISCLOSURE

To achieve a more excellent display effect, sizes of screens configured for terminals are increasing.

During use of a terminal, a user often holds the terminal with both hands to cause the terminal to be in a landscape state, and uses both thumbs to perform touch operations on a screen simultaneously.

However, with increasing sizes of screens, it is impossible to touch an entire screen region with both thumbs even if a terminal is held by both hands. As a result, a holding posture needs to be continuously adjusted during use of the terminal to achieve touch control of the entire screen region.

### SUMMARY

This application provides an interface control method and apparatus, a terminal and a storage medium, which can improve efficiency of an one-handed operation in a landscape state. The technical solutions are as follows:

According to one aspect, an embodiment of this application provides an application interface control method, performed by a computer device, including:

displaying an application interface in a landscape state, the application interface including operable elements, and the operable elements including at least one first operable element located in a one-handed operation region and at least one second operable element located outside the one-handed operation region;

receiving a shielding operation on a light sensor of the computer device, the light sensor being configured to collect light intensity of an environment in which the computer device is located, and the light sensor being located in the one-handed operation region in the landscape state; and

based on the shielding operation, shifting the second operable element into the one-handed operation region of the application interface.

According to another aspect, an embodiment of this application provides a computer device, including a processor and a memory, the memory storing computer programs that, when executed by the processor, cause the computer device to implement the interface control method according to the foregoing aspect.

According to another aspect, an embodiment of this application provides a non-transitory computer-readable storage medium, storing computer program that, when executed by a processor of a computer device, cause the computer device to implement the application interface control method according to the foregoing aspect.

The technical solutions provided in the embodiments of this application include at least the following beneficial effects:

In a landscape state, a terminal may be triggered, by shielding a light sensor located in a one-handed operation region, to control an application interface to move, to cause an operable element originally located outside the one-handed operation region to move into the one-handed operation region, so that a user can perform, with one hand, a touch operation on the operable element that cannot be touched originally, without adjusting a holding posture in the landscape state. This helps improve efficiency of the one-handed operation in the landscape state. In addition, the foregoing interface control function is implemented by reusing the existing light sensor of the terminal and by using a simple operation gesture, without increasing additional hardware costs or additional interface controls.

### BRIEF DESCRIPTION OF THE DRAWINGS

FIG. 1 is a schematic diagram of a one-handed operation region and a position for disposing a light sensor according to an exemplary embodiment of this application.

FIG. 2 is a flowchart of an interface control method according to an exemplary embodiment of this application.

FIG. 3 is a schematic diagram of an interface movement process according to an exemplary embodiment of this application.

FIG. 4 is a conceptual diagram of an operable element classification process according to an exemplary embodiment of this application.

FIG. 5 is a flowchart of an interface control method according to another exemplary embodiment of this application.

FIG. 6 is a schematic diagram of controlling movement of an interface through a tap shielding operation according to an exemplary embodiment of this application.

FIG. 7 is a conceptual diagram illustrating a process of determining a movement distance when an interface moves to the left according to an exemplary embodiment of this application.

FIG. 8 is a conceptual diagram illustrating a process of determining a movement distance when an interface moves to the right according to an exemplary embodiment of this application.

FIG. 9 is a flowchart of an interface control method according to another exemplary embodiment of this application.

FIG. 10 is a schematic diagram of controlling movement of an interface through a touch and hold shielding operation according to an exemplary embodiment of this application.

FIG. 11 is a schematic diagram of controlling an interface to move in a reverse direction by taping a blank region according to an exemplary embodiment of this application.

FIG. 12 is a schematic diagram of controlling an interface to move in a reverse direction by touching and holding a blank region according to an exemplary embodiment of this application.

FIG. 13 is a schematic diagram of controlling an interface to restore by touching a blank region according to an exemplary embodiment of this application.

FIG. 14 is a schematic diagram showing a case of accidentally shielding a light sensor according to an exemplary embodiment of this application.

FIG. 15 is a structural block diagram of an interface control apparatus according to an exemplary embodiment of this application.

FIG. 16 is a schematic diagram of a structure of a terminal according to an exemplary embodiment of this application.

### DESCRIPTION OF EMBODIMENTS

Exemplary embodiments are described in detail herein, and examples thereof are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. Instead, they are merely examples of the apparatus and method according to some aspects of this application as recited in the appended claims.

“Several” mentioned in the specification means one or more, and “plurality of” means two or more. “And/or” describes an association relationship for describing associated objects and represents that three relationships may exist. For example, A and/or B may represent the following three cases: only A exists, both A and B exist, and only B exists. The character “/” generally indicates an “or” relationship between the associated objects.

Terms involved in embodiments of this application are briefly introduced below.

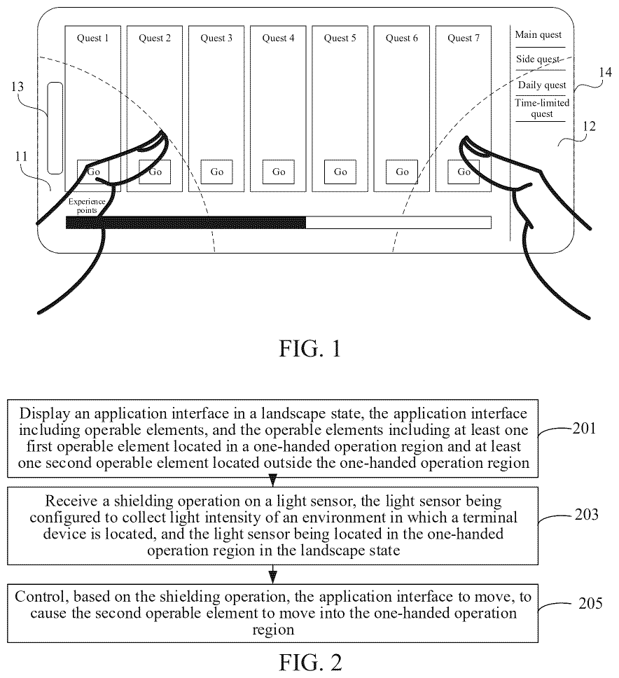

One-handed operation region: It refers to a screen region that can be reached by one hand without changing a holding posture. In some embodiments, the one-handed operation region refers to a terminal screen region in which it is convenient for a user to perform a one-handed operation. In the embodiments of this application, the one-handed operation region refers to a screen region reachable by both thumbs in a landscape state, and includes one-handed operation regions respectively corresponding to a left thumb and a right thumb. For example, as shown in FIG. 1, in a landscape state, a left thumb corresponds to a left-handed one-handed operation region 11, and a right thumb corresponds to a right-handed one-handed operation region 12. The left-handed one-handed operation region refers to a screen region reachable individually by a left hand, and the right-handed one-handed operation region refers to a screen region reachable individually by a right hand.

Light sensor: a sensor configured to collect light intensity of an environment in which a terminal device is located. In some embodiments, the light sensor may be disposed at any position of the terminal device, for example, on a screen side of a terminal device, on a back side of the terminal device, or near a charging port of the terminal device. Generally, the light sensor is disposed in an edge region or a corner region of the screen. In some designs, components such as the light sensor and a front camera are disposed in a notch region (or water drop-shaped region) of the screen. In some other designs, components such as the light sensor and a camera are disposed in a punctured region at a corner of the screen. To avoid impact of screen display on the light sensor, no image display is performed in a region of the screen directly facing the light sensor. For example, as shown in FIG. 1, the light sensor is disposed in a notch region 13 of the screen.

In the landscape state, when holding a terminal device with both hands, a user usually performs touch operations by using two thumbs. With an increasing screen size of the terminal device, a touch region by the two thumbs cannot completely cover the entire screen. As shown in FIG. 1, the left-handed one-handed operation region 11 and the right-handed one-handed operation region 12 cannot completely cover the entire screen. When the user needs to display content in the middle of the screen, the user needs to adjust the holding posture of both hands.

The landscape state means that the terminal screen displays an application interface in the landscape state. A portrait state means that the terminal screen displays an application interface in a vertical state. In some embodiments, the landscape state and the portrait state of the terminal device may be determined based on a size of the terminal screen. For example, the terminal screen is in the shape of a rectangle. If a length of the rectangle is at a top end, the terminal device is in the landscape state. If a width of the rectangle is at the top end, the terminal device is in the portrait state.

To improve efficiency of a one-handed operation in the landscape state, in the embodiments of this application, in the landscape state, when receiving a shielding operation on the light sensor, the terminal device controls the application interface to move, to cause an operable element originally located outside the one-handed operation region to move into the one-handed operation region, so that the user performs a touch operation on the operable element with one hand.

The foregoing interface control function is implemented by reusing the existing light sensor. Therefore, this increases no additional hardware costs or requires no additional control to be disposed on the application interface. In addition, interface control can be implemented by using a simple shielding operation, and therefore, the user does not need to learn and use a complex control gesture. This helps improve interface control efficiency, thereby improving the efficiency of the one-handed operation.

The solutions provided in the embodiments of this application are applicable to a terminal device with a touchscreen and provided with a light sensor. The terminal device may be a smartphone, a tablet computer, an e-book reader, or the like. This is not limited in the embodiments of this application. In the embodiments of this application, the terminal device may also be referred to as a terminal for short.

FIG. 2 is a flowchart of an interface control method according to an exemplary embodiment of this application. The method is performed by a terminal device, and includes the following operations:

Operation 201: Display an application interface in a landscape state, the application interface including operable elements, and the operable elements including at least one first operable element located in a one-handed operation region and at least one second operable element located outside the one-handed operation region.

The operable element may be a control (such as a key or a scroll bar), a link, multimedia content (such as a video or audio), or the like in the interface. A specific type of the operable element is not limited in the embodiments of this application.

In some embodiments, the terminal device obtains an element attribute of an interface element in the application interface, and determines the operable element based on the element attribute. In one embodiment, the operable element is an interface element having a specific element attribute.

For a manner of determining the one-handed operation region, in a possible implementation, the one-handed operation region is configured by default, or the one-handed operation region is determined based on a historical touch point position in the landscape state.

In one embodiment, the one-handed operation region may include a first one-handed operation region and a second one-handed operation region located on two sides of a screen, respectively corresponding to one-handed operation ranges of a left thumb and a right thumb.

In one embodiment, the one-handed operation region may be a sector region, a rectangular region, or the like. This is not limited in the embodiments of this application.

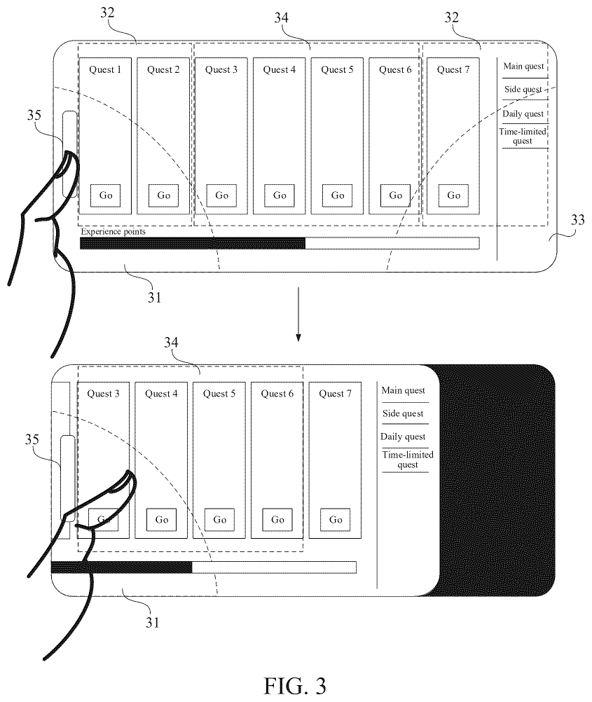

For example, as shown in FIG. 3, operable elements (“Go” keys) corresponding to “quest 1” and “quest 2” are first operable elements 32 located in a first one-handed operation region 31, an operable element corresponding to “quest 7” is a first operable element 32 located in a second one-handed operation region 33, and operable elements corresponding to “quest 3”, “quest 4”, “quest 5”, and “quest 6” are second operable elements 34 located outside the one-handed operation region.

Regarding a manner of determining the first operable element and the second operable element, in some embodiments, the terminal device determines the first operable element and the second operable element based on relative positional relationships between the operable elements and the one-handed operation regions.

In one embodiment, if there is an intersection between the operable element and the one-handed operation region, and a ratio of a size of the intersection to a size of the operable element is greater than a ratio threshold (for example, 30%), it is determined that the operable element is the first operable element. If there is no intersection between the operable element and the one-handed operation region, or there is an intersection and a ratio of a size of the intersection to a size of the operable element is less than a ratio threshold, it is determined that the operable element is the second operable element.

For example, as shown in FIG. 4, two sides of the terminal screen include one-handed operable regions 41, and a region between the one-handed operation regions 41 is a one-handed inoperable region 42. For an operable element 43 whose width is D, when a width of the one-handed operable region is T1, and a distance between a center of the operable element 43 and an edge of the screen is T2, a width C of an intersection between the operable element 43 and the one-handed inoperable region 42 is equal to T2−T1+D/2. If C>0.7D, it is determined that the operable element 43 is a second operable element. If C<0.7D, it is determined that the operable element 43 is a first operable element.

Operation 203: Receive a shielding operation on a light sensor, the light sensor being configured to collect light intensity of an environment in which the terminal device is located, and the light sensor being located in the one-handed operation region in the landscape state.

In some embodiments, the light sensor is located at a position corresponding to the one-handed operation region on the terminal device. Exemplarily, the light sensor is located on a back side of the terminal device corresponding to a left-handed one-handed operation region. For example, the light sensor may be located on the back side of the terminal device corresponding to the left-handed one-handed operation region 11 shown in FIG. 1. Exemplarily, the light sensor may be located on a side surface of the terminal device. For example, the light sensor may be located on a side surface of the terminal device adjacent to the one-handed operation region, for example, at a position 14 shown in FIG. 1. If the light sensor is disposed at the position 14, it is also convenient for the user to perform an operation.

Next, in the embodiments of this application, the technical solutions of the embodiments of this application are exemplarily described by using an example in which a light sensor is disposed on a screen side of the terminal device. The light sensor is configured to collect light intensity on a screen side, so that the terminal device adjusts screen display brightness or an on/off state based on the light intensity. For example, the screen display brightness is increased in strong light, and the screen display brightness is reduced in weak light. The screen side is a side of the terminal screen, and a position at which the light sensor is located may be considered as a part of the terminal screen.

In the embodiments of this application, the light sensor is located in the one-handed operation region in the landscape state. For example, when the terminal device is a smartphone, the light sensor is disposed at a top edge of the screen. The top edge of the screen refers to a top edge of the screen of the smartphone in a portrait state, for example, near a position at which a camera is disposed. In the landscape state, the light sensor is located in the one-handed operation region.

For detecting whether a shielding operation on the light sensor is received, in a possible implementation, the terminal device obtains light intensity outputted by the light sensor, and determines that the light sensor is shielded if the light intensity is less than an intensity threshold or if a range of a change in the light intensity reaches a range threshold.

For example, as shown in FIG. 3, the light sensor is disposed in a notch region 35 at the top of the screen. In the landscape state, the light sensor is located in the first one-handed operation region 31, and the user may shield the light sensor with the left thumb.

Operation 205: Control, based on the shielding operation, the application interface to move, to cause the second operable element to move into the one-handed operation region.

The one-handed operation region is usually located on the two sides of the screen in the landscape state, and it is not easy to operate the operable element in a middle region of the screen with one hand. Therefore, in some embodiments, the terminal device controls, based on the shielding operation, the application interface to move laterally, to cause the second operable element originally located in the middle region of the screen to move into the edge region of the screen, so that the user operates the second operable element with one hand.

For example, as shown in FIG. 3, when the shielding operation is received, the terminal device controls the application interface to move into the left, so that second operable elements 34 (operable elements corresponding to the “task 3” and the “task 4”) originally located outside the one-handed operation region move into the first one-handed operation region 31.

After the terminal device controls the application interface to move as a whole, a part of the application interface is within a screen display range, and a part of the application interface moves out of the screen display range. In this case, there is a blank region (that is, a region with no application interface) on the screen. As shown in FIG. 3, after the application interface moves to the left, there is a blank region (that is, a black region in the figure) on the right side of the screen.

In some embodiments, when the shielding operation is received, the terminal device further needs to detect whether a foreground application is a target application (the target application is an application that supports movement of an interface in the landscape state), and whether the application interface includes a second operable element. If the foreground application is a target application and the application interface includes a second operable element, the application interface is controlled to move. If the foreground application is not a target application, and/or the application interface includes no second operable element, the application interface is not to be controlled to move, so as to reduce impact of an accidental shielding operation.

Although the shielding operation on the light sensor affects the light intensity outputted by the light sensor, the terminal device does not adjust the screen display brightness or the on/off state of the screen according to the changing light intensity.

In conclusion, in this embodiment of this application, in the landscape state, the terminal device may be triggered, by shielding the light sensor located in the one-handed operation region, to control the application interface to move, to cause an operable element originally located outside the one-handed operation region to move into the one-handed operation region, so that a user can perform, with one hand, a touch operation on the operable element that cannot be touched originally, without adjusting a holding posture in the landscape state. This helps improve efficiency of the one-handed operation in the landscape state. In addition, the foregoing interface control function is implemented by reusing the existing light sensor of the terminal device and by using a simple operation gesture, without increasing additional hardware costs or additional interface controls.

In a possible design, the shielding operation for triggering movement of the application interface may be a single shielding operation or a continuous shielding operation, and under different types of shielding operations, the terminal device controls movement of the application interface in different manners.

In a possible implementation, when receiving the shielding operation on the light sensor, the terminal device further determines an operation type of the shielding operation, and controls, based on the operation type, the application interface to move in a corresponding movement manner. The terminal device may determine the operation type by detecting shielding duration of the shielding operation. For example, when the shielding duration does not exceed a duration threshold (for example, 200 ms), it is determined that the operation type is a single shielding operation. When the shielding duration exceeds the duration threshold, it is determined that the operation type is a continuous shielding operation.

In some embodiments, the single shielding operation may include a shielding operation that shields light for short duration, such as a tap shielding operation or a slide shielding operation. The continuous shielding operation may include a shielding operation that shields light for long duration, such as a touch and hold shielding operation or a drag shielding operation. A shielding operation that can be identified by the light sensor is not limited in this application, and may be set by a developer or based on settings of various operations in a target application. For example, if a touch and hold operation is identified, the target application provides corresponding feedback. Therefore, during determining of the shielding operation, the touch and hold shielding operation is not considered, so as to avoid triggering of the feedback from the target application.

The following describes movement processes of the application interface under a single shielding operation and a continuous shielding operation respectively by using embodiments.

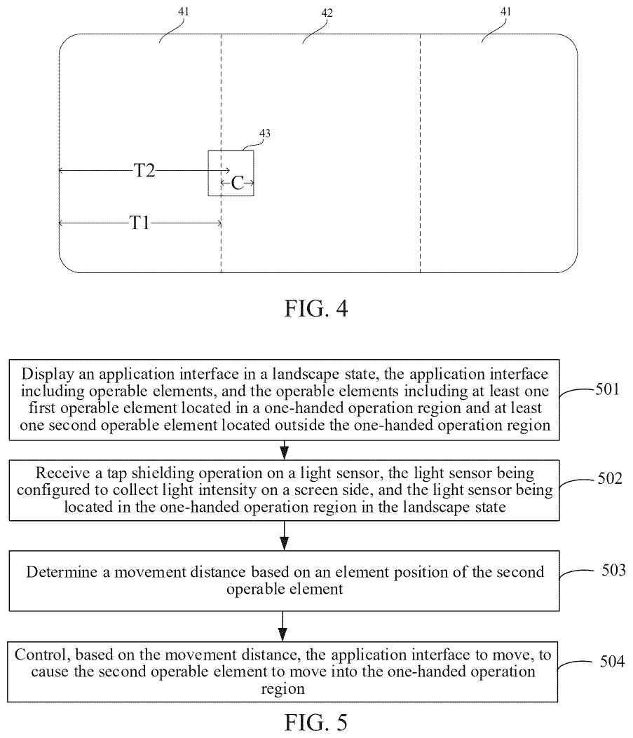

FIG. 5 is a flowchart of an interface control method according to another exemplary embodiment of this application. The method is performed by a terminal device. A tap shielding operation is used as an example in this embodiment to illustrate exemplary implementation of interface control through a single shielding operation. The method includes the following operations.

Operation 501: Display an application interface in a landscape state, the application interface including operable elements, and the operable elements including at least one first operable element located in a one-handed operation region and at least one second operable element located outside the one-handed operation region.

For an implementation of this operation, refer to operation 201. Details are not described again in this embodiment.

Operation 502: Receive a tap shielding operation on a light sensor, the light sensor being configured to collect light intensity of an environment in which the terminal device is located, and the light sensor being located in the one-handed operation region in the landscape state.

In a possible implementation, when the shielding operation on the light sensor is detected and shielding duration is less than a duration threshold, the terminal device determines that the tap shielding operation is received.

Operation 503: Determine a movement distance based on an element position of the second operable element. In one embodiment, each tap shielding operation is configured for triggering the application interface to move by a specific distance, and different tap shielding operations may trigger the interface to move by the same distance or different distances. When the movement distance is a fixed distance, the movement distance may be a width of an operable region.

To ensure that each time after the tap shielding operation is performed, some operable elements originally located outside the one-handed operation region move into the one-handed operation region, the terminal device needs to determine, based on element positions of second operable elements currently located outside the one-handed operation region, a movement distance of the application interface under the current tap shielding operation. In a possible implementation, operation 503 may include the following sub-operations:

I. Determine a target operable element, a distance between the target operable element and a screen side being less than a distance between another second operable element and the screen side.

The another second operable element refers to a second operable element other than the target operable element.

In some embodiments, each time when the tap shielding operation is received, the terminal device determines a second operable element closest to the screen side as the target operable element, to determine a current movement distance of the application interface by using a position of the target operable element as a reference.

In one embodiment, because the one-handed operation region is usually located on two sides of the screen in the landscape state, an operable element originally located outside the one-handed operation region can be moved into the one-handed operation region by laterally moving the application interface to the left or right. A movement direction of the application interface may be set by the terminal device by default, or may be customized by a user, or may even be determined based on a user habit (for example, based on a dominant hand). A specific manner of determining the movement direction is not limited in this embodiment of this application.

In some embodiments, in different movement directions, the target operable element is determined in different manners.

In a possible implementation, when the movement direction of the application interface is from a second screen side to a first screen side, the terminal device determines the target operable element based on a distance between the second operable element and the first screen side. The target operable element is a second operable element closest to the first screen side.

When the movement direction of the application interface is from the first screen side to the second screen side, the terminal device determines the target operable element based on a distance between the second operable element and the second screen side. The target operable element is a second operable element closest to the second screen side.

In one embodiment, the terminal device obtains element horizontal coordinates (such as center coordinates or vertex coordinates) of each second operable element, to determine a distance from the first screen side or the second screen side based on the element horizontal coordinates, to determine the target operable element based on the distance.

In some embodiments, when the movement direction of the application interface is from the first screen side to the second screen side, the terminal device determines, in the at least one second operable element, a second operable element with a smallest distance from the second screen side as the target operable element.

In some embodiments, when the movement direction of the application interface is from the second screen side to the first screen side, the terminal device determines, in the at least one second operable element, a second operable element with a smallest distance from the first screen side as the target operable element.

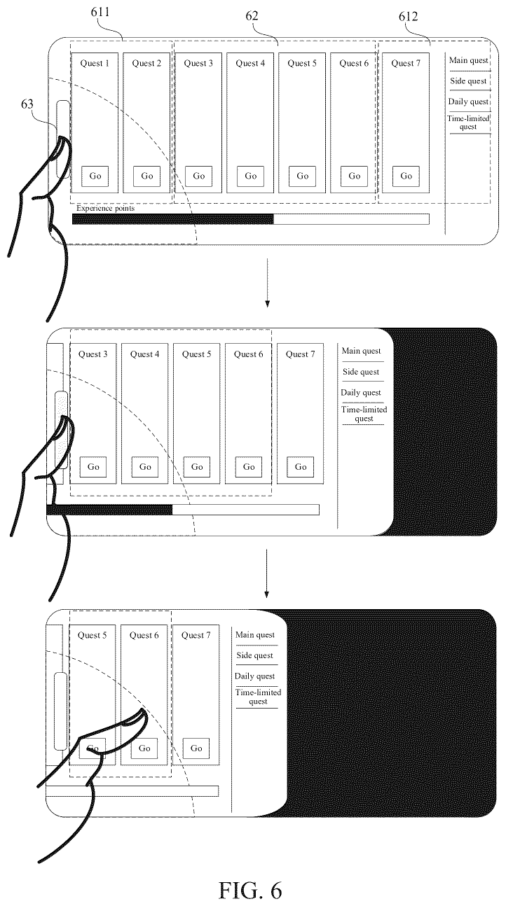

For example, as shown in FIG. 6, the screen includes a left one-handed operation region 611 and a right one-handed operation region 612, and a one-handed inoperable region 62 is included between the two one-handed operation regions. When the movement direction of the application interface is from a right side of the screen to a left side of the screen, the terminal device determines an operable element corresponding to the “quest 3” in the one-handed inoperable region 62 as the target operable element. When the movement direction of the application interface is from the left side of the screen to the right side of the screen, the terminal device determines an operable element corresponding to the “quest 6” in the one-handed inoperable region 62 as the target operable element. In the following embodiments, an example in which the operable element corresponding to the “quest 3” is determined as the target operable element is used for description.

The target operable element is determined based on the distance between the second operable element and the screen side and the movement direction of the application interface, and a position of the target operable element is used as a reference factor for the movement distance of the application interface, to prevent the second operable element from becoming untouchable after it is moved out of the one-handed operation region, thereby improving operation accuracy.

II. Determine the movement distance based on an element position of the target operable element.

In a possible design, a security region is provided on the terminal screen (usually at the top or the bottom of the screen). The security region is not configured for image display, but is configured for disposing components such as a front camera, a sensor, and an earpiece. The light sensor is located in the security region, and the security region is located on the first screen side in the landscape state.

To avoid a case that during the process of moving the application interface, due to movement of the operable element to the security region, touching on the operable element fails, or a misoperation is caused by accidentally shielding the light sensor in the security region when the operable element is touched, in a possible implementation, there may include the following two possibilities for the terminal device for determining the movement distance.

1. When the movement direction of the application interface is from the second screen side to the first screen side, the terminal device determines the movement distance based on a distance between the target operable element and the first screen side, a width of the security region, an element width of the target operable element.

In one embodiment, when the movement direction is from the second screen side to the first screen side, because the application interface passes through the security region during movement, in order to prevent the second operable element after the movement from being located in the security region, the terminal device determines the movement distance based on the distance between the target operable element and the first screen side, the width of the security region, and the element width of the target operable element. After the application interface is moved based on the movement distance, the target operable element does not enter the security region.

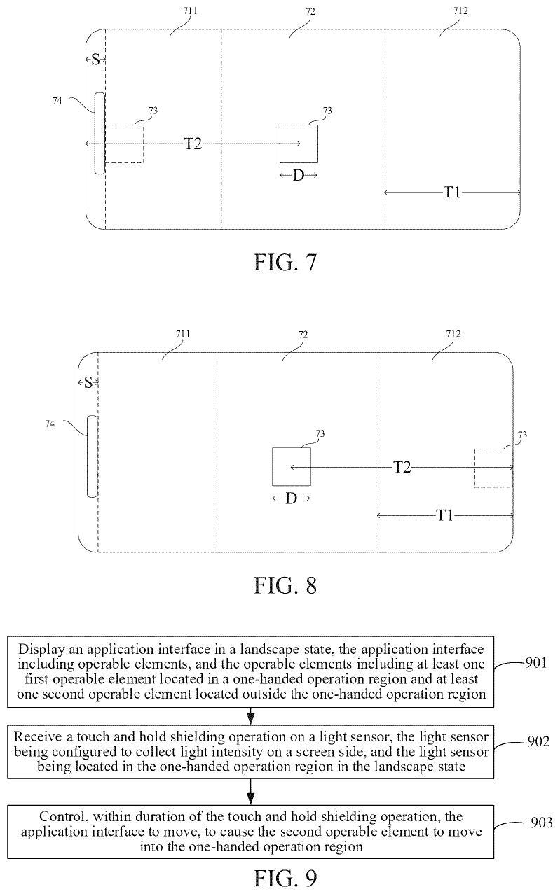

For example, as shown in FIG. 7, the screen includes a left one-handed operation region 711 and a right one-handed operation region 712 (whose widths are both T1), and a one-handed inoperable region 72 is included between the two one-handed operation regions. A light sensor 74 is located in a security region (whose width is S) at the top of the screen, and in the landscape state, the security region is located on a left side of the screen. When a movement direction of the application interface is from a right side of the screen to the left side of the screen, and a distance between a target operable element 73 (whose element width is D) and the left side of the screen is T2 (a distance between an element center and the left side of the screen), a movement distance T is T=T2−S−D/2. That is, after the application interface moves, a left boundary of the target operable element 73 is moved to a right boundary of the security region (in FIG. 7, a solid line represents the target operable element before the movement, and a dashed line represents the target operable element after the movement).

2. When the movement direction of the application interface is from the first screen side to the second screen side, the terminal device determines the movement distance based on a distance between the target operable element and the second screen side and an element width of the target operable element.

When the movement direction is from the first screen side to the second screen side, because the second screen side does not include the security region, the target operable element may move into the second screen side.

For example, as shown in FIG. 8, the screen includes a left one-handed operation region 711 and a right one-handed operation region 712 (whose widths are both T1), and a one-handed inoperable region 72 is included between the two one-handed operation regions. A light sensor 74 is located in a security region (whose width is S) at the top of the screen, and in the landscape state, the security region is located on a left side of the screen. When a movement direction of the application interface is from the left side of the screen to a right side of the screen, and a distance between a target operable element 73 (whose element width is D) and the right side of the screen is T2 (a distance between an element center and the left side of the screen), a movement distance T is T=T2−D/2. That is, after the application interface moves, a right boundary of the target operable element 73 moves to the right side of the screen (in FIG. 8, a solid line represents the target operable element before the movement, and a dashed line represents the target operable element after the movement).

Through the foregoing method, during determining of the movement distance of a single movement, a positional relationship between the movement direction and the security region is fully considered, to avoid a case that due to movement of the operable element to the security region, the operable element becomes untouchable or the light sensor is accidentally shielded, thereby further improving operation accuracy.

Operation 504: Control, based on the movement distance, the application interface to move, to cause the second operable element to move into the one-handed operation region.

Further, the terminal device controls, based on the movement direction and the determined movement distance, the application interface to move, and after the application interface moves, some or all of the second operable elements move into the one-handed operation region.

For example, as shown in FIG. 6, when the user taps, for the first time, to shield the light sensor located in a notch region 63 at the top of the screen, the terminal device controls the application interface to move from right to left, so that the operable elements corresponding to the “task 3” and the “task 4” originally located in the one-handed inoperable region 62 definitely move into the left one-handed operation region 611. Because operable elements corresponding to the “task 5” and the “task 6” are still located in the one-handed inoperable region 62, the user may tap again to shield the light sensor located in the notch region 63 at the top of the screen, to cause the application interface to move from right to left again, so that the operable elements corresponding to the “task 5” and the “task 6” originally located in the one-handed inoperable region 62 definitely move into the left one-handed operation region 611.

In some embodiments, the terminal device controls, based on the determined movement distance, the application interface to move. A possible implementation is that the movement distance is determined based on the position of the second operable element described in operation 503.

In some embodiments, the movement distance may be determined based on a width of the one-handed operation region. Exemplarily, the width of the one-handed operation region is determined as the movement distance. Exemplarily, the movement distance is less than the width of the one-handed operation region. In some embodiments, the movement distance may alternatively be a default value. For example, the movement distance is a default value customized by the user, and each time when the terminal device moves the application interface, the default value serves as the movement distance. Certainly, the movement distance may alternatively be determined in another manner. This is not limited in this application.

In this embodiment, through single shielding of the light sensor, the user can control the application interface to perform a single movement, to cause an operable element originally located in the one-handed inoperable region to move into the one-handed operation region, thereby improving efficiency of a one-handed operation in the landscape state. In addition, during determining of the movement distance for the single movement, the second operable element with the smallest distance from the screen side is first determined as the target operable element. The movement direction, a positional relationship between the target operable element and the screen side, and a positional relationship between the target operable element and the security region are fully considered, to avoid a case that due to movement of the operable element into the security region or out of the one-handed operation region, the operable element becomes untouchable or the light sensor is accidentally shielded, thereby further improving operation accuracy.

FIG. 9 is a flowchart of an interface control method according to another exemplary embodiment of this application. The method is performed by a terminal device. A touch and hold shielding operation is used an example in this embodiment to illustrate exemplary implementation of interface control through a continuous shielding operation. The method includes the following operations:

Operation 901: Display an application interface in a landscape state, the

application interface including operable elements, and the operable elements including at least one first operable element located in a one-handed operation region and at least one second operable element located outside the one-handed operation region.

For an implementation of this operation, refer to operation 201. Details are not described again in this embodiment.

Operation 902: Receive a touch and hold shielding operation on a light sensor, the light sensor being configured to collect light intensity of an environment in which the terminal device is located, and the light sensor being located in the one-handed operation region in the landscape state.

In a possible implementation, when the shielding operation on the light sensor is detected and shielding duration is greater than a duration threshold, the terminal device determines that the touch and hold shielding operation is received.

Operation 903: Control, within duration of the touch and hold shielding operation, the application interface to move, to cause the second operable element move into the one-handed operation region.

Different from controlling, each time after a tap shielding operation is performed, the application interface to move by a specific distance, when the application interface is controlled through the touch and hold shielding operation to move, the application interface continues to move within the duration of the touch and hold shielding operation, and stops moving when the touch and hold shielding operation ends. Therefore, a user can control the movement distance of the application interface by controlling operation duration of the touch and hold shielding operation, thereby implementing more accurate interface movement control.

In one embodiment, a movement direction of the application interface may be set by the terminal device by default, or may be customized by a user, or may even be determined based on a user habit (for example, based on a dominant hand). A specific manner of determining the movement direction is not limited in this embodiment of this application.

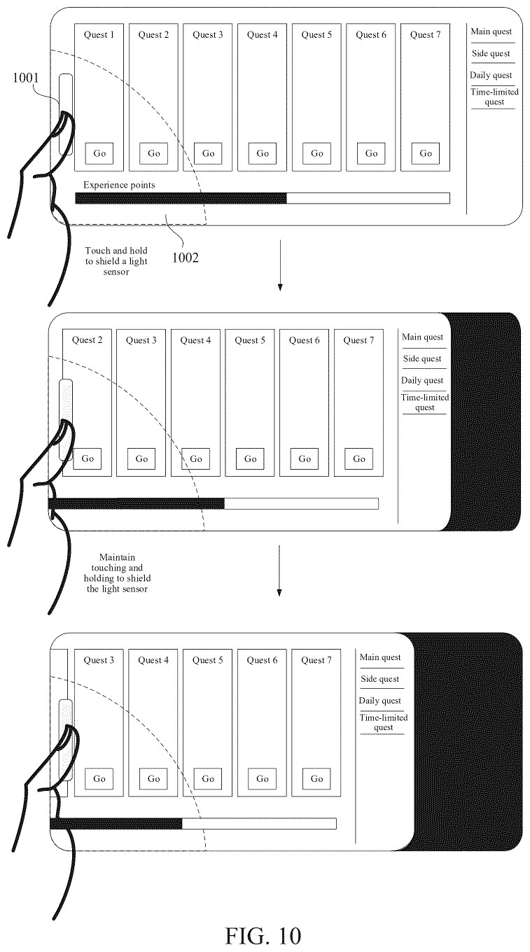

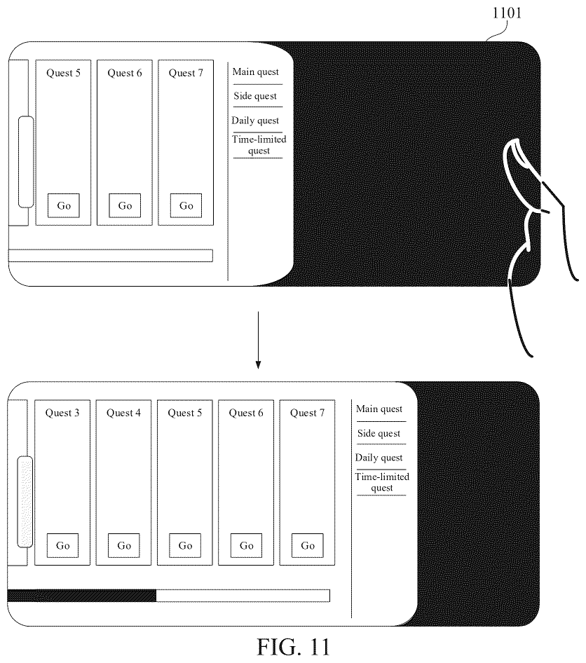

For example, as shown in FIG. 10, in a process in which the user uses the left thumb to touch and hold a light sensor located in a notch region 1001 at the top of the screen, the application interface moves to the left at a movement speed, and an operable element originally located outside a one-handed operation region 1002 gradually moves into the one-handed operation region 1002.

Regarding the movement speed of the application interface under the touch and hold shielding operation, in a possible implementation, the terminal device controls, at a first movement speed within the duration of the touch and hold shielding operation, the application interface to move, the first movement speed being a default movement speed.

In one embodiment, the default movement speed may be set by the terminal device by default, or may be preset by the user before using the function. For example, the default movement speed is 100 px/s, that is, the application interface moves at a speed of 100 px per second.

For different users, sizes of one-handed operation regions are different, and correspondingly, sizes of one-handed inoperable regions are also different. Therefore, to improve accuracy and efficiency of performing interface control operations by different users, in another possible implementation, the terminal device determines a second movement speed based on a region width of an operation region outside the one-handed operation region, and thus controls, at the second movement speed within the duration of the touch and hold shielding operation, the application interface to move.

The second movement speed is positively correlated with the region width. To be specific, a larger region width of the one-handed inoperable region indicates a higher second movement speed, and correspondingly, the application interface in the one-handed inoperable region can pass through the one-handed operation region more quickly. A smaller region width of the one-handed inoperable region indicates a lower second movement speed.

In one embodiment, the terminal device may determine the current second movement speed based on a correspondence between the second movement speed and the region width, or calculate the second movement speed based on the region width and default movement duration. This is not limited in this embodiment.

In an illustrative example, when the region width of the one-handed inoperable region is 500 px, the terminal device determines that the second movement speed is 100 px, and when the region width of the one-handed operation inoperable is 400 px, the terminal device determines that the second movement speed is 80 px.

Because positions of operable elements in different application interfaces differ greatly, in order to cause the second operable element to move into the one-handed operation region as soon as possible, in a possible implementation, the terminal device determines, in the at least one second operable element, the target operable element and further determines a first distance between the target operable element and a one-handed operable region, so as to control, within the first distance at a third movement speed, the application interface to move, and to control, outside the first distance at a fourth movement speed, the application interface to move, that is, control, at the third movement speed before the target operable element enters the one-handed operable region, the application interface to move, and control, at the fourth movement speed after the target operable element enters the one-handed operable region, the application interface to move, the third movement speed being greater than the fourth movement speed. This ensures both operation efficiency (the target operable element is controlled at the third movement speed to quickly enter the one-handed operation region) and operation accuracy (the target operable element moves slowly after entering the one-handed operation region, which helps the user accurately control the movement distance).

For a manner of determining the target operable element, refer to the foregoing embodiment. Details are not described in this embodiment again.

In an illustrative example, when the distance between the target operable element and the one-handed operable region is 100 px, and the width of the one-handed inoperable region is 400 px, within the duration of the touch and hold shielding operation, the terminal device first controls the application interface to move by 100 px at a movement speed of 100 px/s, and then controls the application interface to move by 400 px at a movement speed of 60 px/s.

In this embodiment, the user can control, by performing the touching and hold shielding operation on the light sensor, the application interface to move within the duration of the shielding operation, so that the operable element can move into the operable region under accurate control by the user. In addition, the movement speed of the application interface may be dynamically determined according to the region width of the one-handed inoperable region. This helps improve efficiency of moving the operable element outside the one-handed operation region into the one-handed operation region.

In a process of controlling movement of the application interface by using the foregoing tap shielding operation or touch and hold shielding operation, excessive movement may occur due to an improper operation (for example, an excessive quantity of taps or excessively long touch and hold duration), resulting in a problem that a to-be-touched operable element moves out of a screen display range.

To help the user make up for an improper operation, in a possible implementation, when the shielding operation is the tap shielding operation, in response to a tap operation on a blank region, the terminal device controls, based on a historical movement distance, the application interface to move in a reverse direction, the blank region being a region with no application interface formed after the application interface moves.

In some embodiments, the terminal device records each movement distance when controlling, based on each tap shielding operation, the application interface to move. When receiving the tap operation on the blank region, the terminal device controls, based on a reverse order of a recording sequence of the movement distances, the application interface to move in a reverse direction.

For example, if the application interface moves to the left by 100 px when a first shielding operation is received, and the application interface moves to the left by 120 px when a second shielding operation is received, a first tap operation on the blank region triggers the application interface to move into the right by 120 px, and a second tap operation on the blank region triggers the application interface to move into the right by 100 px.

For example, as shown in FIG. 11, when the user taps to shield the light sensor with the left thumb to control the application interface to move from right to left, due to an improper operation of one more tap for shielding, the operable element, originally to be touched, corresponding to the “quest 3” moves out of the screen display range. In this case, the user may tap a blank region 1101 with the right thumb, to control the application interface to move from left to right, so that the operable element corresponding to the “quest 3” moves into the screen display range again to facilitate the touch by the user.

In another possible implementation, when the shielding operation is the touch and hold shielding operation, in response to a touch and hold operation on a blank region, the application interface is controlled, within duration of the touch and hold operation, to move in a reverse direction. The blank region is a region with no application interface formed after the application interface moves.

In one embodiment, when the touch and hold operation on the blank region stops, the application interface stops moving in the reverse direction.

In one embodiment, a speed at which the application interface moves in the reverse direction is consistent with a speed at which the application interface moves in a forward direction.

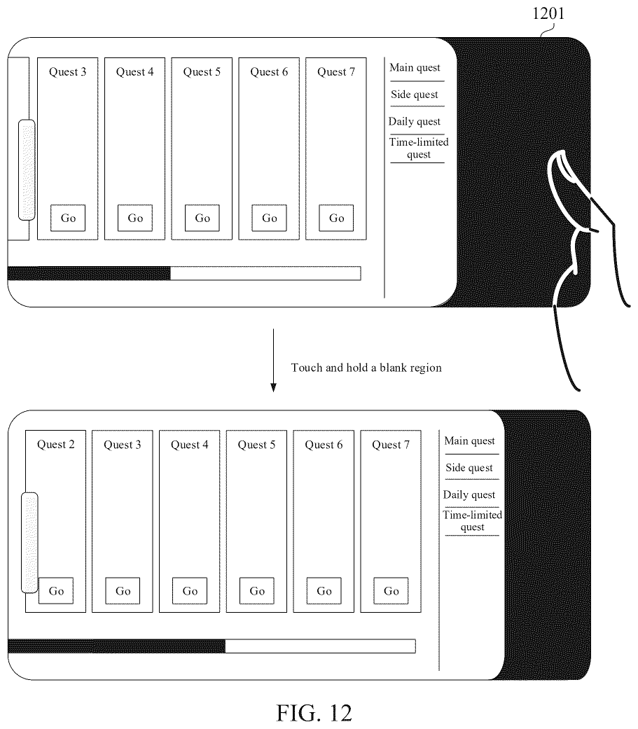

For example, as shown in FIG. 12, when the user touches and holds to shield the light sensor with the left thumb to control the application interface to move from right to left, due to excessively long duration of the touching and holding, an operable element to be touched originally moves out of a screen display range. In this case, the user may touch and hold a blank region 1201 with the right thumb to control the application interface to move from left to right, so that the operable element to be touched moves into the screen display range again to facilitate the touch by the user.

To enable the user to learn that taping the blank region may control the application interface to move in a reverse direction, in some embodiments, the terminal device may display corresponding prompt information in the blank region. The prompt information may be text, an animation, or the like.

In this embodiment, a reverse movement mechanism is set, so that when the shielding operation is improper, the user can tap the blank region to retract the previous improper operation, thereby helping improve operation accuracy.

When the application interface moves laterally under the shielding operation, although operable elements originally located outside the one-handed operation region can move into the one-handed operation region, some operable elements originally located in the one-handed operation region move out of the one-handed operation region. For example, when an operable element in the one-handed inoperable region moves into the left-handed one-handed operation region, an operable element in the right-handed one-handed operation region moves into the one-handed inoperable region.

To enable the user to continue performing a touch operation on an operable element originally located in the one-handed operation region after completing a touch operation on an operable element that has moved into the one-handed operation region, in a possible implementation, the terminal device restores the application interface when receiving a touch operation on the blank region.

In one embodiment, the touch operation may be a one-handed touch operation such as a touch and hold operation, a one-tap operation, or a continuous-tap operation. This is not limited in this embodiment.

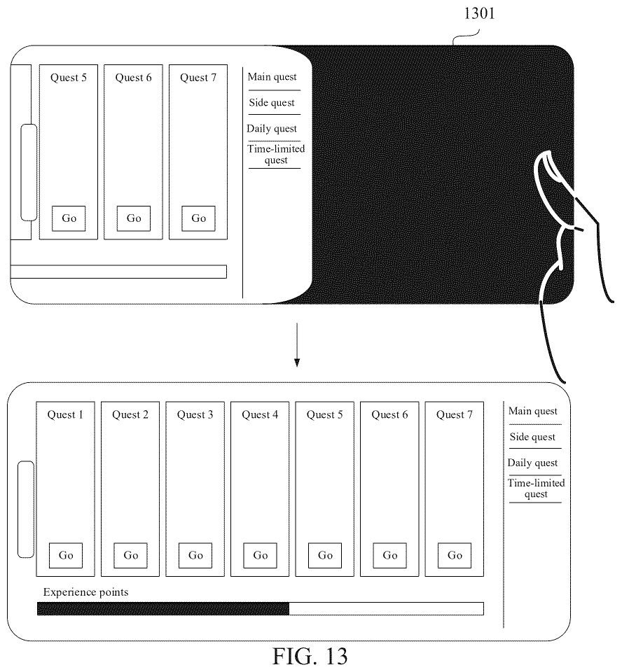

For example, as shown in FIG. 13, when the user taps a blank region 1301, the terminal device restores the application interface, so that the user continues to perform an operation on another interface region with one hand.

The blank region may be configured for implementing both the reverse movement operation and the interface restoration operation, and operation types for triggering the reverse movement operation and the restoration operation are different. For example, a single-tap operation or a touch and hold operation on the blank region may trigger reverse movement, and a continuous-tap operation on the blank region may trigger interface restoration.

Because the light sensor is located in the one-handed operation region, when the user performs a touch operation on an operable element in the one-handed operation region (with no interface movement requirement), the terminal device may mistakenly identify the shielding operation. To reduce a probability of misidentification, in a possible implementation, when the one-handed operation region includes a first one-handed operation region and a second one-handed operation region (respectively located on two sides of the screen), and the light sensor is located in the first one-handed operation region, when the shielding operation on the light sensor is received and there is no touch operation in the second one-handed operation region, the application interface is controlled, based on the shielding operation, to move.

In one embodiment, when the shielding operation on the light sensor is received and there is a touch operation in the second one-handed operation region, the terminal device does not respond to the shielding operation, that is, does not control the application interface to move.

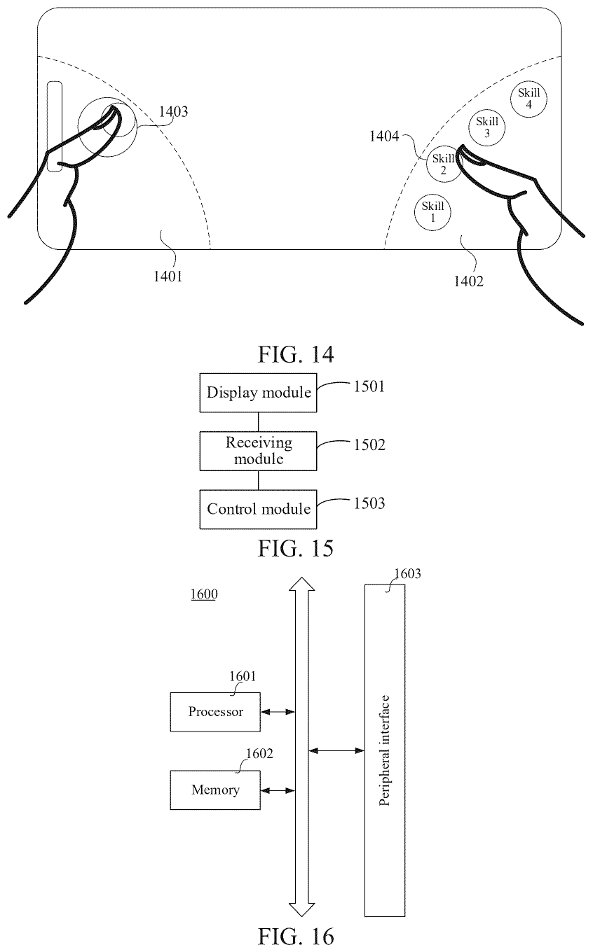

For example, as shown in FIG. 14, a joystick control 1403 is disposed in a left-handed one-handed operation region 1401, and a skill control 1404 is disposed in a right-handed one-handed operation region 1402. When the user controls the joystick control 1403 with the left thumb and controls the skill control 1404 with the right thumb, even if the left thumb shields the light sensor located in the notch region of the screen, because there is a touch operation in the right-handed operation region, the terminal device does not control the application interface to move, thereby preventing accidental movement of the interface from affecting the operation by the user.

To further improve accuracy of identifying the shielding operation, in some embodiments, the terminal device obtains sensor data of the light sensor when the shielding operation on the light sensor is received and there is a touch operation in the second one-handed operation region.

When both the shielding operation and the touch operation in the second one-handed operation region are detected, it indicates that the current shielding operation on the light sensor is a misoperation. Therefore, the terminal device collects sensor data of the light sensor at this time, that is, collects misidentification data.

Further, the terminal device corrects a shielding operation identification threshold based on the sensor data. The shielding operation identification threshold is a sensor data threshold for identifying the shielding operation.

In a possible implementation, the terminal device determines, based on the sensor data of the light sensor and the sensor data threshold, whether there is a shielding operation. The terminal device may correct the sensor data threshold by using collected misidentification data, so that such an accidental shielding operation can be subsequently identified based on the corrected sensor data threshold, thereby improving operation accuracy.

In an illustrative example, the sensor data threshold in an initial state is 100 lux. When the sensor data collected during the accidental shielding operation is 80 lux, 86 lux, and 75 lux, respectively, the terminal device adjusts the sensor data threshold to 70 lux.

In each of the foregoing embodiments, an example in which the application interface moves laterally in the landscape state is used as an example for description. When the terminal screen is relatively high, not only a lateral region on the screen cannot be operated with one hand, but also some vertical regions on the screen cannot be operated with one hand.

In a possible implementation, while controlling, based on the shielding operation, the application interface to move laterally, the terminal device further obtains attitude data outputted by an attitude sensor within duration of the shielding operation, thereby controlling, based on the attitude data, the application interface to move vertically.

In one embodiment, the attitude sensor may be an acceleration sensor, an angular velocity sensor, a gyroscope sensor, or the like. This is not limited in this embodiment.

In one embodiment, after obtaining the attitude data, the terminal device determines, based on the attitude data, an attitude change status of the terminal device within the duration of the shielding operation. When the attitude change status indicates that the terminal device is tilted toward the top, the terminal device controls the application interface to move upward. When the attitude change status indicates that the terminal device is tilted toward the bottom, the terminal device controls the application interface to move downward.

In one embodiment, when the shielding operation ends, the terminal device stops obtaining the attitude data, and maintains a current display state of the application interface.

According to the foregoing method, the terminal device may determine the movement direction of the application interface based on the attitude data outputted by the attitude sensor, to allow the application interface to move both laterally and vertically, so that a personalized requirement of the user can be met.

FIG. 15 is a structural block diagram of an interface control apparatus according to an exemplary embodiment of this application. The apparatus includes:

a display module 1501, configured to display an application interface in a landscape state, the application interface including operable elements, and the operable elements including at least one first operable element located in a one-handed operation region and at least one second operable element located outside the one-handed operation region;

a receiving module 1502, configured to receive a shielding operation on a light sensor, the light sensor being configured to collect light intensity of an environment in which a terminal device is located, and the light sensor being located in the one-handed operation region in the landscape state; and

a control module 1503, configured to control, based on the shielding operation, the application interface to move, to cause the second operable element to move into the one-handed operation region.

In one embodiment, the control module 1503 includes:

a first control unit, configured to control, when the shielding operation is a tap shielding operation and based on a determined movement distance, the application interface to move; and

a second control unit, configured to control, when the shielding operation is a touch and hold shielding operation and within duration of the touch and hold shielding operation, the application interface to move.

In one embodiment, the movement distance is determined based on an element position of the second operable element; and the first control unit is configured to:

determine a target operable element in the at least one second operable element, a distance between the target operable element and a screen side being less than a distance between a second operable element other than the target operable element and the screen side; and

determine the movement distance based on an element position of the target operable element.

In one embodiment, the first control unit is configured to:

determine, when a movement direction of the application interface is from a second screen side to a first screen side, the movement distance based on a distance between the target operable element and the first screen side, a width of a security region, and an element width of the target operable element; or

determine, when a movement direction of the application interface is from a first screen side to a second screen side, the movement distance based on a distance between the target operable element and the second screen side and an element width of the target operable element;

where the light sensor being located in the security region, and in the landscape state, the security region being located at the first screen side and the second screen side being opposite to the first screen side.

In one embodiment, the first control unit is configured to:

determine, when the movement direction of the application interface is from the second screen side to the first screen side, the target operable element based on a distance between the second operable element and the first screen side; or

determine, when the movement direction of the application interface is from the first screen side to the second screen side, the target operable element based on a distance between the second operable element and the second screen side.

In one embodiment, the second control unit is configured to:

control, at a first movement speed within the duration of the touch and hold shielding operation, the application interface to move, the first movement speed being a default movement speed; or

determine a second movement speed based on a region width of an operation

region outside the one-handed operation region, the second movement speed being positively correlated with the region width; and control, at the second movement speed within the duration of the touch and hold shielding operation, the application interface to move.

In one embodiment, the control module 1503 is further configured to:

control, when the shielding operation is the tap shielding operation, based on a historical movement distance in response to a tap operation on a blank region, the application interface to move in a reverse direction; or

control, when the shielding operation is the touch and hold shielding operation, in response to a touch and hold operation on a blank region within duration of the touch and hold operation, the application interface to move in a reverse direction;

where the blank region being a region with no application interface formed after the application interface moves.

In one embodiment, the control module 1503 is further configured to:

restore the application interface when a touch operation on the blank region is received, the blank region being a region with no application interface formed after the application interface moves.

In one embodiment, the control module 1503 is further configured to:

control, based on the shielding operation, the application interface to move laterally; and

obtain attitude data outputted by an attitude sensor within duration of the shielding operation, and control, based on the attitude data, the application interface to move vertically.

In one embodiment, the one-handed operation region includes a first one-handed operation region and a second one-handed operation region, the first one-handed operation region and the second one-handed operation region are located at two sides of a screen, and the light sensor is located in the first one-handed operation region; and

the control module 1503 is further configured to

control, based on the shielding operation when the shielding operation on the light sensor is received and there is no touch operation in the second one-handed operation region, the application interface to move.

In one embodiment, the apparatus further includes

a correction module, configured to obtain sensor data of the light sensor when the shielding operation on the light sensor is received and there is a touch operation in the second one-handed operation region; and correct a shielding operation identification threshold based on the sensor data, the shielding operation identification threshold being a sensor data threshold for identifying the shielding operation.

In conclusion, in this embodiment of this application, in the landscape state, the terminal device may be triggered, by shielding the light sensor located in the one-handed operation region, to control the application interface to move, to cause an operable element originally located outside the one-handed operation region to move into the one-handed operation region, so that a user can perform, with one hand, a touch operation on the operable element that cannot be touched originally, without adjusting a holding posture in the landscape state. This helps improve efficiency of the one-handed operation in the landscape state. In addition, the foregoing interface control function is implemented by reusing the existing light sensor of the terminal device and by using a simple operation gesture, without increasing additional hardware costs or additional interface controls.

The apparatus provided in the foregoing embodiment is illustrated only with an example of division of the foregoing function modules. In practical applications, the foregoing functions may be allocated to and completed by different function modules according to requirements. That is, the internal structure of the apparatus is divided into different function modules to complete all or some of the functions described above. In addition, the apparatus and method embodiments provided in the foregoing embodiments belong to the same conception. For an implementation process, reference may be made to the method embodiments, and details are not described herein again.

FIG. 16 is a block diagram of a structure of a terminal device 1600 according to an exemplary embodiment of this application. The terminal device 1600 may be a portable mobile terminal, such as a smartphone, a tablet computer, a moving picture experts group audio layer III (MP3) player, or a moving picture experts group audio layer IV (MP4) player. The terminal device 1600 may also be referred to as other names such as user equipment and a portable terminal.

Generally, the terminal device 1600 includes a processor 1601 and a memory 1602.

The processor 1601 may include one or more processing cores, for example, a 4-core processor or an 8-core processor. The processor 1601 may be implemented by using any one of the following hardware forms: a digital signal processor (DSP), a field-programmable gate array (FPGA), and a programmable logic array (PLA). The processor 1601 may also include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1601 may be integrated with a graphics processing unit (GPU), which is responsible for rendering and drawing a content required to be displayed by a display screen. In some embodiments, the processor 1601 may further include an artificial intelligence (AI) processor, which is configured to process a computing operation related to machine learning.

The memory 1602 may include one or more computer-readable storage media. The computer-readable storage medium may be tangible and non-transitory. The memory 1602 may further include a high-speed random access memory and a nonvolatile memory, for example, one or more magnetic disk storage devices or flash storage devices. In some embodiments, the non-transitory computer-readable storage medium in the memory 1602 is configured to store at least one instruction, the at least one instruction being configured to be executed by the processor 1601 to implement the method provided in the embodiments of this application.

In some embodiments, the terminal device 1600 may alternatively include: a peripheral device interface 1603 and at least one peripheral device.

In this embodiment of this application, the peripheral device includes an optical sensor. The optical sensor is configured to collect ambient light intensity. In an embodiment, the processor 1601 may control display brightness of a touch display screen according to the ambient light intensity collected by the optical sensor. When the ambient light intensity is relatively high, the display brightness of the touch display screen is increased. When the ambient light intensity is relatively low, the display brightness of the touch display screen is decreased.

A person skilled in the art may understand that the structure shown in FIG. 16 constitutes no limitation on the terminal device 1600, and the terminal device 1600 may include more or fewer components than those shown in the figure, or some components may be combined, or a different component deployment may be used.

An embodiment of this application further provides a computer-readable storage medium, storing at least one instruction, the at least one instruction being loaded and executed by a processor to implement the interface control method described in the foregoing embodiments.

An embodiment of this application provides a computer program product, including a computer instruction, the computer instruction being stored in a computer-readable storage medium. A processor of a computer device reads the computer instruction from the computer-readable storage medium and executes the computer instruction, to cause the computer device to perform the interface control method described in the foregoing embodiments.

The at least one instruction, the at least one program, and the computer instruction in the embodiments of this application may all be collectively referred to as a computer program. Details are not described again in the embodiments of this application.

In this application, before user-related data is collected and during collection of the user-related data, a prompt interface or a pop-up window can be displayed, or voice prompt information can be outputted. The prompt interface, the pop-up window, or the voice prompt information is configured for prompting the user that user-related data is currently being collected. In this way, in this application, related operations of obtaining the user-related data start to be performed only after a confirmation operation of the user on the prompt interface or the pop-up window is obtained. Otherwise (that is, when no confirmation operation of the user on the prompt interface or the pop-up window is obtained), the related operations of obtaining the user-related data are ended, that is, the user-related data is not to be obtained. In other words, all user data (including an operable element, a one-handed operation region, or the like in a target application) collected in this application is processed in strict accordance with the requirements of relevant national laws and regulations. The informed consent or separate consent of a personal information subject is collected with the consent and authorization of the user, subsequent data use and processing activities are carried out within the scope of laws, regulations, and the authorization of the personal information subject, and the collection, use and processing of user-related data need to comply with relevant laws, regulations, and standards of relevant countries and regions.

A person of ordinary skill in the art may understand that all or some of the operations of the foregoing embodiments may be implemented by hardware, or may be implemented by a program instructing relevant hardware. The program may be stored in a computer-readable storage medium. The aforementioned storage medium may be a read-only memory, a magnetic disk, an optical disc, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely embodiments of this application, but are not intended to limit this application. Any modification, equivalent replacement, or improvement made within the spirit and principle of this application shall fall within the protection scope of this application.

What is claimed is:

1. An application interface control method performed by a computer device, comprising:
displaying an application interface in a landscape state, the application interface comprising operable elements, and the operable elements comprising at least one first operable element located in a one-handed operation region and at least one second operable element located outside the one-handed operation region;
receiving a shielding operation on a light sensor of the computer device, the light sensor being configured to collect light intensity of an environment in which the computer device is located, and the light sensor being located in the one-handed operation region in the landscape state; and
based on the shielding operation, shifting the second operable element into the one-handed operation region of the application interface.

2. The method according to claim 1, wherein the shifting the second operable element into the one-handed operation region of the application interface comprises:
when the shielding operation is a tap shielding operation on the light sensor, shifting the second operable element into the one-handed operation region of the application interface by a determined movement distance; and
when the shielding operation is a touch and hold shielding operation on the light sensors, continuously shifting the second operable element into the one-handed operation region of the application interface within a duration of the touch and hold shielding operation.

3. The method according to claim 2, wherein the movement distance is determined based on an element position of the second operable element on the application interface; and
the shifting the second operable element into the one-handed operation region of the application interface by a determined movement distance comprises:
determining a target operable element in the at least one second operable element, a distance between the target operable element and a screen side associated with the one-handed operation region being less than a distance between a second operable element other than the target operable element and the screen side; and
determining the movement distance based on an element position of the target operable element in the application interface.

4. The method according to claim 3, wherein the determining the movement distance based on an element position of the target operable element in the application interface comprises:
determining, when a movement direction of the application interface is from a second screen side to a first screen side, the movement distance based on a distance between the target operable element and the first screen side, a width of a security region, and an element width of the target operable element; and
determining, when a movement direction of the application interface is from a first screen side to a second screen side, the movement distance based on a distance between the target operable element and the second screen side and an element width of the target operable element;
the light sensor being located in the security region, and in the landscape state, the security region being located at the first screen side and the second screen side being opposite to the first screen side.

5. The method according to claim 4, wherein the determining a target operable element in the at least one second operable element comprises:
determining, when the movement direction of the application interface is from the second screen side to the first screen side, the target operable element based on a distance between the second operable element and the first screen side; or
determining, when the movement direction of the application interface is from the first screen side to the second screen side, the target operable element based on a distance between the second operable element and the second screen side.

6. The method according to claim 2, wherein the continuously shifting the second operable element into the one-handed operation region of the application interface within a duration of the touch and hold shielding operation comprises:
continuously shifting the second operable element into the one-handed operation region of the application interface at a first movement speed within the duration of the touch and hold shielding operation, the first movement speed being a default movement speed; or
determining a second movement speed based on a region width of an operation region outside the one-handed operation region, the second movement speed being positively correlated with the region width; and continuously shifting the second operable element into the one-handed operation region of the application interface at the second movement speed within the duration of the touch and hold shielding operation.

7. The method according to claim 1, further comprising:
causing the application interface to move in a reverse direction based on a historical movement distance in response to a tap operation on a blank region;
wherein the blank region is a region with no application interface after shifting the second operable element into the one-handed operation region of the application interface.

8. The method according to claim 1, further comprising:
restoring the application interface in response to a touch operation on a blank region, wherein the blank region is a region with no application interface after shifting the second operable element into the one-handed operation region of the application interface.

9. The method according to claim 1, further comprising:
obtaining attitude data outputted by an attitude sensor within a duration of the shielding operation; and
controlling the application interface to move vertically based on the attitude data.

10. The method according to claim 1, wherein the one-handed operation region comprises a first one-handed operation region and a second one-handed operation region, the first one-handed operation region and the second one-handed operation region are located at two opposite sides of a screen, and the light sensor is located in the first one-handed operation region.

11. The method according to claim 10, further comprising:
obtaining sensor data of the light sensor when the shielding operation on the light sensor is received and there is a touch operation in the second one-handed operation region; and
correcting a shielding operation identification threshold based on the sensor data, the shielding operation identification threshold being a sensor data threshold for identifying the shielding operation.

12. A computer device, comprising a processor and a memory, the memory storing computer programs that, when executed by the processor, cause the computer device to implement an application interface control method including:
displaying an application interface in a landscape state, the application interface comprising operable elements, and the operable elements comprising at least one first operable element located in a one-handed operation region and at least one second operable element located outside the one-handed operation region;
receiving a shielding operation on a light sensor of the computer device, the light sensor being configured to collect light intensity of an environment in which the computer device is located, and the light sensor being located in the one-handed operation region in the landscape state; and
based on the shielding operation, shifting the second operable element into the one-handed operation region of the application interface.

13. The computer device according to claim 12, wherein the shifting the second operable element into the one-handed operation region of the application interface comprises:
when the shielding operation is a tap shielding operation on the light sensor, shifting the second operable element into the one-handed operation region of the application interface by a determined movement distance; and
when the shielding operation is a touch and hold shielding operation on the light sensors, continuously shifting the second operable element into the one-handed operation region of the application interface within a duration of the touch and hold shielding operation.

14. The computer device according to claim 12, wherein the method further comprises:
causing the application interface to move in a reverse direction based on a historical movement distance in response to a tap operation on a blank region;
wherein the blank region is a region with no application interface after shifting the second operable element into the one-handed operation region of the application interface.

15. The computer device according to claim 12, wherein the method further comprises:
restoring the application interface in response to a touch operation on a blank region, wherein the blank region is a region with no application interface after shifting the second operable element into the one-handed operation region of the application interface.

16. The computer device according to claim 12, wherein the method further comprises:
obtaining attitude data outputted by an attitude sensor within a duration of the shielding operation; and
controlling the application interface to move vertically based on the attitude data.

17. The computer device according to claim 12, wherein the one-handed operation region comprises a first one-handed operation region and a second one-handed operation region, the first one-handed operation region and the second one-handed operation region are located at two opposite sides of a screen, and the light sensor is located in the first one-handed operation region.

18. The computer device according to claim 17, wherein the method further comprises:
obtaining sensor data of the light sensor when the shielding operation on the light sensor is received and there is a touch operation in the second one-handed operation region; and
correcting a shielding operation identification threshold based on the sensor data, the shielding operation identification threshold being a sensor data threshold for identifying the shielding operation.

19. A non-transitory computer-readable storage medium, storing computer programs that, when executed by a processor of a computer device, cause the computer device to implement an application interface control method including:
displaying an application interface in a landscape state, the application interface comprising operable elements, and the operable elements comprising at least one first operable element located in a one-handed operation region and at least one second operable element located outside the one-handed operation region;
receiving a shielding operation on a light sensor of the computer device, the light sensor being configured to collect light intensity of an environment in which the computer device is located, and the light sensor being located in the one-handed operation region in the landscape state; and
based on the shielding operation, shifting the second operable element into the one-handed operation region of the application interface.

20. The non-transitory computer-readable storage medium according to claim 19, wherein the shifting the second operable element into the one-handed operation region of the application interface comprises:
when the shielding operation is a tap shielding operation on the light sensor, shifting the second operable element into the one-handed operation region of the application interface by a determined movement distance; and
when the shielding operation is a touch and hold shielding operation on the light sensors, continuously shifting the second operable element into the one-handed operation region of the application interface within a duration of the touch and hold shielding operation.
